(19) United States
(12) Patent Application Publication
(10) Pub. No.: US 2016/0090038 A1
(43) Pub. Date: Mar. 31, 2016

(54) DANGER ZONE WARNING SYSTEM

(71) Applicant: INTERNATIONAL BUSINESS MACHINES CORPORATION, Armonk, NY (US)

(72) Inventors: Simon A. S. Briggs, Hursley (GB); James K. Hook, Hursley (GB); Hamish C. Hunt, Hursley (GB); Nicholas K. Lincoln, Hursley (GB)

(21) Appl. No.: 14/864,301

(22) Filed: Sep. 24, 2015

(30) Foreign Application Priority Data
Sep. 26, 2014 (GB) 1417053.4

(51) Int. Cl. B60Q 9/00

(52) U.S. Cl. CPC B60Q 9/008

(57) ABSTRACT

Providing a danger zone warning. A volume is determined, and the volume is modeled. One or more danger zones within the volume are determined, wherein a danger zone is a sub-volume of the volume which is or will become hazardous for a person to be in. A visual indication is provided on the ground of a danger zone. Also, a directed audio warning is provided to a danger zone. A danger zone may be monitored for entry of a person into the danger zone, and one or both of the visual indication and the directed audio warning may be provided when an entry is detected.

### PRIOR FOREIGN APPLICATION

This application claims priority from United Kingdom (GB) patent application number 1417053.4, filed Sep. 26, 2014, which is hereby incorporated herein by reference in its entirety.

### BACKGROUND

One or more aspects of the invention relate to the field of warning systems for people in danger zones. In particular, one or more aspects relate to a danger zone warning system for pedestrians or cyclists entering a dangerous area.

Lorries and other large vehicles have a problem with visibility. Their wing and rear-view mirrors do not provide a clear view for the driver of the entire area around the vehicle. Wing mirrors only provide a view of a segment along the side of the vehicle leaving an area known as a “blind spot” which cannot be seen by the driver.

This results in many accidents involving pedestrians, bicycles, motorcycles and other small road users who unwittingly enter a blind spot of a large vehicle driver. The location of these blind spots, and therefore, danger zones are not apparent to a road user, particularly when the large vehicle is in the process of turning a corner.

In a common scenario, cyclists may pull up next to a large articulated lorry at a set of traffic lights or other junction. The cyclists may think they can be seen by the driver of the lorry, but in fact they may be completely in a blind spot, and therefore, not able to be seen by the driver of the lorry. The lorry may turn across the cyclists' paths as it leaves the traffic lights or junction and this may result in an accident. A lorry driver's blind spot is large enough that several bicycles are hidden from view.

Current emphasis is on the vehicle driver to be aware of pedestrians and/or cyclists that may be in these danger zones. Existing technology revolves around automatically adjusting the driver's wing mirrors based upon where a driver is looking or to account for articulated vehicles.

Any sensible cyclist or pedestrian would never knowingly enter these danger zones; however, it is very difficult to know the area where a driver's blind spot covers. Often, cyclists actually think that they are in a safe zone when in fact they are not.

At present, heavy goods vehicles only warn while reversing, with an audible alarm. This is the extent of “active warning” that is provided.

Therefore, there is a need in the art to address the aforementioned problems.

### SUMMARY

In accordance with an aspect of the present invention, a computer-implemented method of providing a danger zone warning is provided. The method includes identifying, by a processor, a volume, and modeling the volume; determining one or more danger zones within the volume, wherein a danger zone is a sub-volume of the volume hazardous for a person to be in; providing a visual indication on the ground of one danger zone; and providing a directed audio warning to the one danger zone.

In accordance with another aspect of the present invention, a computer system for providing a danger zone warning is provided. The computer system includes a memory; and a processor in communication with the memory, wherein the computer system is configured to perform a method. The method including identifying a volume, and modeling the volume; determining one or more danger zones within the volume, wherein a danger zone is a sub-volume of the volume hazardous for a person to be in; providing a visual indication on the ground of one danger zone; and providing a directed audio warning to the one danger zone.

In accordance with yet another aspect of the present invention, a computer program product for providing a danger zone warning is provided. The computer program product includes a computer readable storage medium readable by a processing circuit and storing instructions for execution by the processing circuit for performing a method. The method includes identifying, by a processor, a volume, and modeling the volume; determining one or more danger zones within the volume, wherein a danger zone is a sub-volume of the volume hazardous for a person to be in; providing a visual indication on the ground of one danger zone; and providing a directed audio warning to the one danger zone.

### BRIEF DESCRIPTION OF THE DRAWINGS

The subject matter regarded as aspects of the invention is particularly pointed out and distinctly claimed in the concluding portion of the specification. Aspects of the invention, both as to organization and method of operation, together with objects, features, and advantages thereof, may best be understood by reference to the following detailed description when read with the accompanying drawings.

Embodiments of the present invention will now be described, by way of example only, with reference to the following drawings in which:

FIG. 1 is one example of a flow diagram of an example embodiment of a method in accordance with an aspect of the present invention;

FIG. 2 is one example of a flow diagram of a further example embodiment of a method in accordance with an aspect of the present invention;

FIG. 3 is one example of a flow diagram of a further example embodiment of a method in accordance with an aspect of the present invention;

FIG. 4 is one example of a block diagram of an example embodiment of a system in accordance with an aspect of the present invention;

FIG. 5 is one example of a block diagram of an embodiment of a computer system in which one or more aspects of the present invention may be implemented; and

FIGS. 6A, 6B, 6C and 6D are example schematic diagrams showing an example embodiment of the system applied to an articulated vehicle.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of aspects of the invention. However, it will be understood by those skilled in the art that aspects of the present invention may be practiced without these specific details. In other instances, well-known methods, procedures, and components have not been described in detail so as not to obscure aspects of the present invention.

A method and system are provided for danger zone warning. A generic volume is considered that may be occupied by a human and, at least some of the time, may include a dangerous region to be within, referred to as a danger zone. For example, this may be an area adjacent a vehicle, within the egress point of an emergency exit or waste vent.

The volume may be modeled for danger zones within the volume and the danger zones may be identified by lights provided on the floor or ground of the danger zone in combination with a directional sound warning system directed to be heard in the danger zone. The lights may be provided continuously or may be activated at required times. Similarly, the sound may be activated at a required time to provide an additional warning.

The danger zone may be monitored for occupation by a person (either on foot or in some form of transport) using a suitable sensor, which may be infra-red based, use image recognition, or other detection method. Based on such a sensor, it is possible to determine if the monitored volume is occupied or not.

Based upon a condition being met, such as a person monitored in the danger zone or such as an emergency alarm being triggered within a building, the system can act to warn anybody within the danger zone of the monitored volume by both audio and visual clues. The danger zone is illuminated in a suitable scheme (for example, red light/laser lines cast onto a floor area) and sound is directed into the danger zone of the monitored volume.

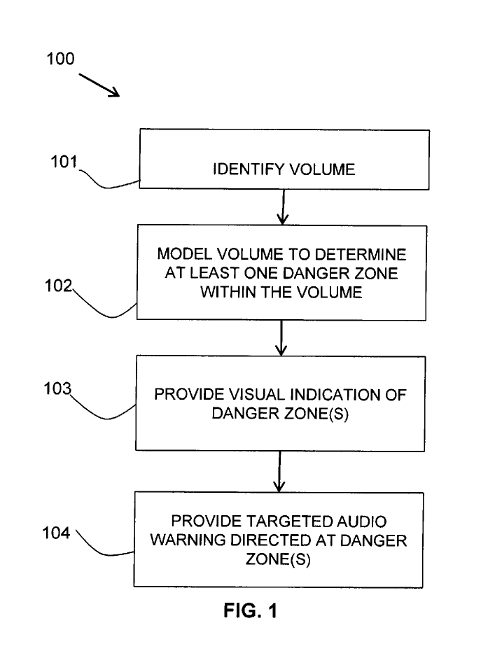

Referring to FIG. 1, a first example aspect of the described method is shown in a flow diagram 100.

A volume or environment is identified 101 and modeled 102 to determine one or more danger zones within the volume. For example, in one embodiment, the volume may be surrounding a large vehicle and the danger zone is modeled as the sub-volume within the volume which can not be seen by the driver of the vehicle—the blind spot. In another embodiment, the volume may be adjacent a waste egress zone and the danger zone may be modeled to be the sub-volume into which waste may move. In a further embodiment, the volume may be an industrial manufacturing space and the danger zone may be modeled as being a sub-volume into which machinery may move.

It should be noted that the danger zone(s) may be moving zones which move with the modeled volume; for example, where the modeled volume is a vehicle or moving machinery.

A visual indication is provided 103 on the floor or ground of the danger zone to demark the danger zone. This may be by lines of light cast onto the floor or solid areas of light. In one embodiment, the light is cast down onto the floor or ground to avoid interference with a person's eyes or vision who is in the danger zone.

A targeted audio warning is also provided 104 directed to the danger zone to avoid noise pollution outside the danger zone. In one embodiment, the directed audio sound is generated by the method used by Holosonics in their Audio Spotlight product (Holosonics and Audio Spotlight are trademarks of Holosonic Research Labs, Inc.). This method uses ultrasound which has short wavelengths of only a few millimeters in length to direct a source of sound into a narrow beam. As the ultrasonic beam travels through the air, the shape of the ultrasound changes in a predictable way. This gives rise to predictable audible frequency components within a directional beam of sound.

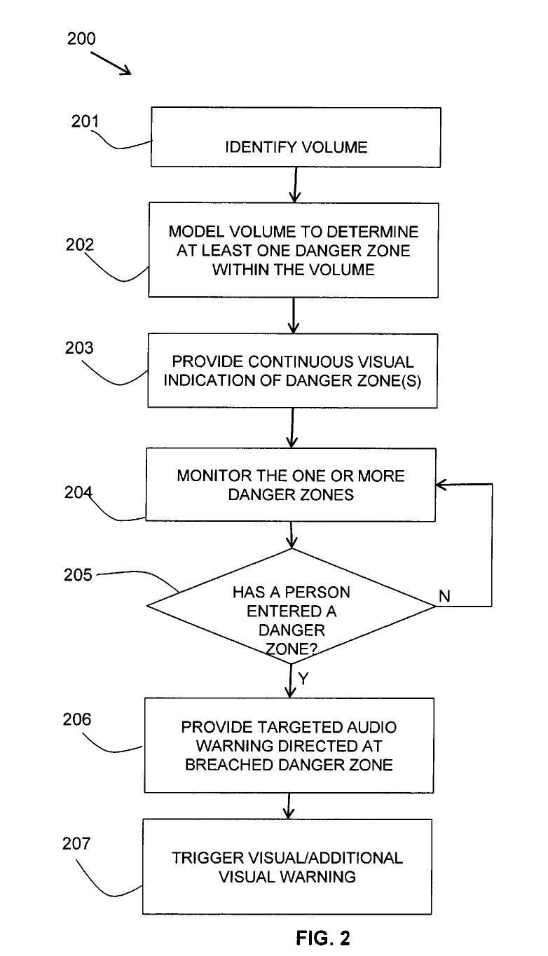

Referring to FIG. 2, an embodiment of the described method is shown in a flow diagram 200 in which the danger zone is monitored for a person entering the danger zone.

A volume is identified 201 and modeled 202 to determine one or more danger zones within the volume.

A visual indication may optionally be provided 203 continuously illuminating the floor or ground of the one or more danger zones.

The one or more danger zones may be monitored 204 and it may be determined 205 if a person enters a danger zone. If it is not determined that a person has entered a danger zone, the danger zones may continue to be monitored 204. However, if it is determined that a person has entered a danger zone, then a directed audio sound may be provided 206 to the breached danger zone. Optionally, if the visual indication has not been continuously provided, the visual indication is also triggered 207 by the determination that a person has entered the danger zone.

If a static visual indication is provided 203, the determination that a person has entered the danger zone may trigger 207 an additional visual warning such as flashing lights.

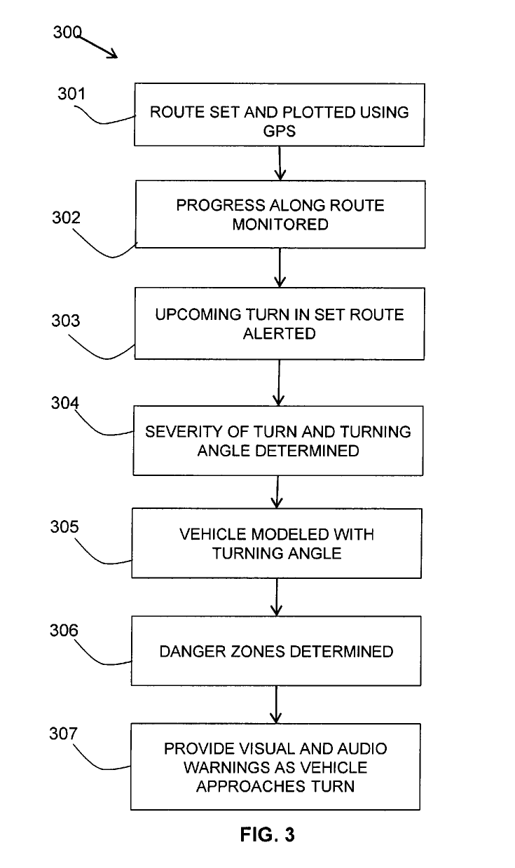

Referring to FIG. 3, a further embodiment of the described method is shown in a flow diagram 300 in which a planned movement is anticipated relating to the volume.

A route to be travelled by a vehicle is set 301 and may be plotted using a GPS (Global Positioning System) system. The progress along the route is monitored 302 using location information. An upcoming junction or sharp turning is alerted 303 based on the plotted route. The severity of the turn is determined 304 and the required turning angle of the vehicle.

The vehicle is modeled 305 including the turning angle, and one or more danger zones are determined 306. The methods as described in FIG. 1 are then followed to provide 307 visual and audio warnings as the vehicle approaches the junction and executes the turn.

In some embodiments, only the visual identification is provided unless a person is monitored in the determined danger zone(s) in which case additional visual and directed audio warnings may be provided.

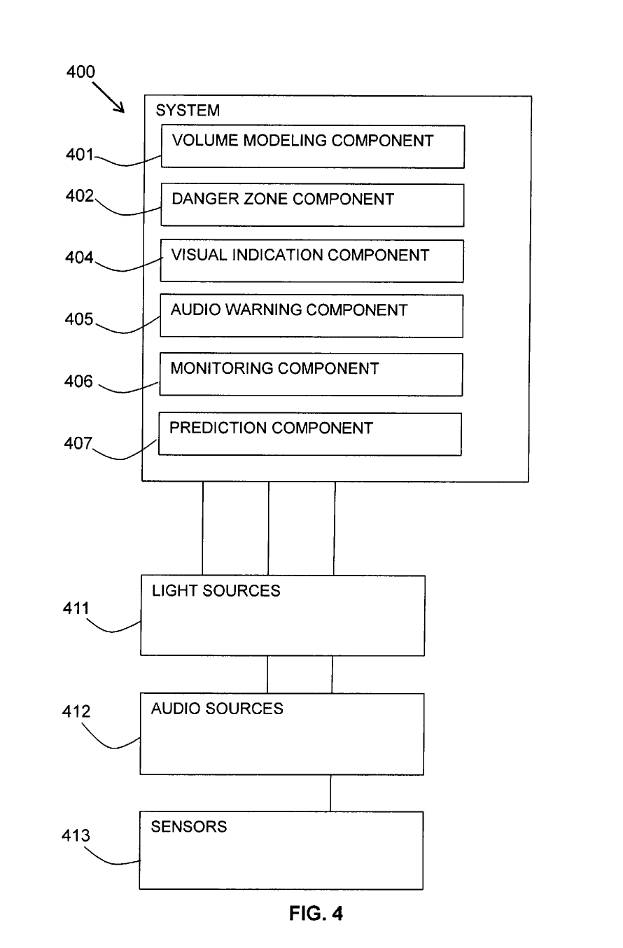

Referring to FIG. 4, one example of a block diagram shows the components of a described system 400.

A danger zone warning system 400 is shown including a volume modeling component 401 for identifying a volume and modeling the volume. A danger zone component 402 may be provided for determining one or more danger zones within the volume, wherein a danger zone is a sub-volume of the volume which is or will become hazardous for a person to be in.

The system 400 may include a visual indication component 404 for providing a visual indication on the ground of a danger zone. The visual indication component 404 may control a plurality of light sources 411 which are focused for illumination of an area of the ground in a danger zone.

The visual indication component 404 may provide a continuous visual indication of the danger zone, or may be triggered by a monitoring component 406 described below. In one embodiment, the visual indication component 404 may provide a continuous visual indication with an additional visual indication provided when triggered by a monitoring component 406.

The system 400 may also include an audio warning component 405 for providing a directed audio warning to a danger zone. The audio warning component 405 may control one or more directed audio sources 412. The audio warning component 405 may be triggered by a monitoring component 406.

The system 400 may also include a monitoring component 406 for monitoring a danger zone for entry of a person into the danger zone and triggering the visual indication component 404 and/or the audio warning component 405. The monitoring component 406 may include a plurality of sensors 413 to monitor movement in a danger zone.

The system 400 may also include a prediction component 407 for predicting a movement of a hazardous object within the volume. The visual indication component 404 and the audio warning component 405 are for providing the visual indication and directed audio warning prior to and/or during the predicted movement.

In one example embodiment, the volume may be an area around a vehicle and the vehicle may be modeled using the vehicle dimensions and determining the driver's position and the orientation of the side mirrors. In this way a danger zone is determined as a volume which is not visible by the driver and through which the vehicle may turn. The vehicle may be an articulated vehicle and the modeling may include modeling the angle of the turn of the vehicle.

The prediction component 407 for predicting a movement of a hazardous object within the volume may predict the movement of a vehicle by determining a vehicle's route and progress along the route.

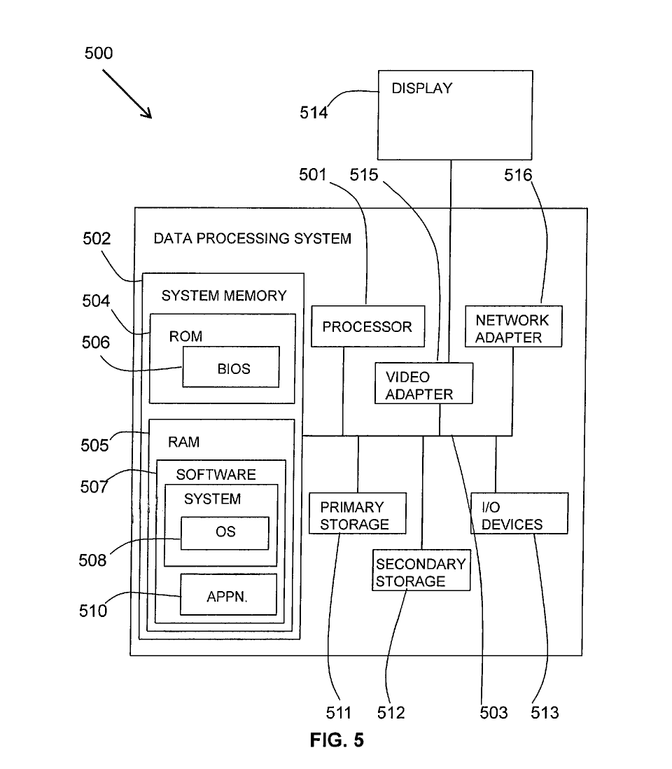

Referring to FIG. 5, one example of a system for implementing aspects of the invention includes a data processing system 500 suitable for storing and/or executing program code including at least one processor 501 coupled directly or indirectly to memory elements through a bus system 503. The memory elements may include local memory employed during actual execution of the program code, bulk storage, and cache memories which provide temporary storage of at least some program code in order to reduce the number of times code is to be retrieved from bulk storage during execution.

The memory elements may include system memory 502 in the form of read only memory (ROM) 504 and random access memory (RAM) 505. A basic input/output system (BIOS) 506 may be stored in ROM 504. System software 507 may be stored in RAM 505 including operating system software 508. Software applications 510 may also be stored in RAM 505.

The system 500 may also include a primary storage means 511, such as a magnetic hard disk drive, and secondary storage means 512, such as a magnetic disc drive and an optical disc drive. The drives and their associated computer-readable media provide non-volatile storage of computer-executable instructions, data structures, program modules and other data for the system 500. Software applications may be stored on the primary and secondary storage means 511, 512 as well as the system memory 502.

The computing system 500 may operate in a networked environment using logical connections to one or more remote computers via a network adapter 516.

Input/output devices 513 may be coupled to the system either directly or through intervening I/O controllers. A user may enter commands and information into the system 500 through input devices, such as a keyboard, pointing device, or other input devices (for example, microphone, joy stick, game pad, satellite dish, scanner, or the like). Output devices may include speakers, printers, etc. A display device 514 is also connected to system bus 503 via an interface, such as video adapter 515.

In one example embodiment, the volume being modeled is a large vehicle. The described method identifies the current danger zone(s) (e.g., blind spot) of the vehicle using modeling of a number of parameters. The parameters may include the driver's position, the orientation of side mirrors, and the vehicle dimensions.

Projecting a visual indicator associated with the determined danger zone may use a lighting system associated with the large vehicle. For example, lights may be provided projecting from the undercarriage of the vehicle to illuminate an area adjacent the side of the vehicle where a danger zone is determined to be.

Monitoring the presence of a cyclist/pedestrian within a danger zone may use sensors and an indicator (e.g., sound) may be used to issue a warning if required. By providing cyclists/pedestrians with the required information, they may make an informed decision relating to their safety around large and dangerous vehicles.

The described method and system provide the ability of a cyclist or pedestrian to be able to see the blind spots of a large vehicle and to be warned that they have entered such a zone. This is advantageous because, as observed above, the blind spots of a vehicle are not intuitive. By providing cyclists/pedestrians with the required information, they may make an informed decision relating to their safety around large and dangerous vehicles.

In the example of a large vehicle a danger zone may have a less dangerous zone within it, for example, the area observable by the driver but still dangerous if the vehicle is turning.

There may be multiple combinations of lighting provided in such scenarios including the following:
danger zone is illuminated, but observable zone is not illuminated;
both danger zone and observable zone are illuminated; or
danger zone and observable zone are illuminated in different colors.

An audible warning is projected to the cyclist/pedestrian using directed sound, such that they are informed audibly that they have entered a dangerous region, which is the same zone indicated by the visual indicator. By the use of directed sound, those outside the dangerous region are not subject to nuisance noise. As above, different combinations of sound warning and visual warnings may be used.

While this is intended, in one example, for the application towards indicating a dangerous zone around a large vehicle, this could be extended to cover instances such as: emergency exits; waste/egress zones; industrial manufacturing areas, etc.

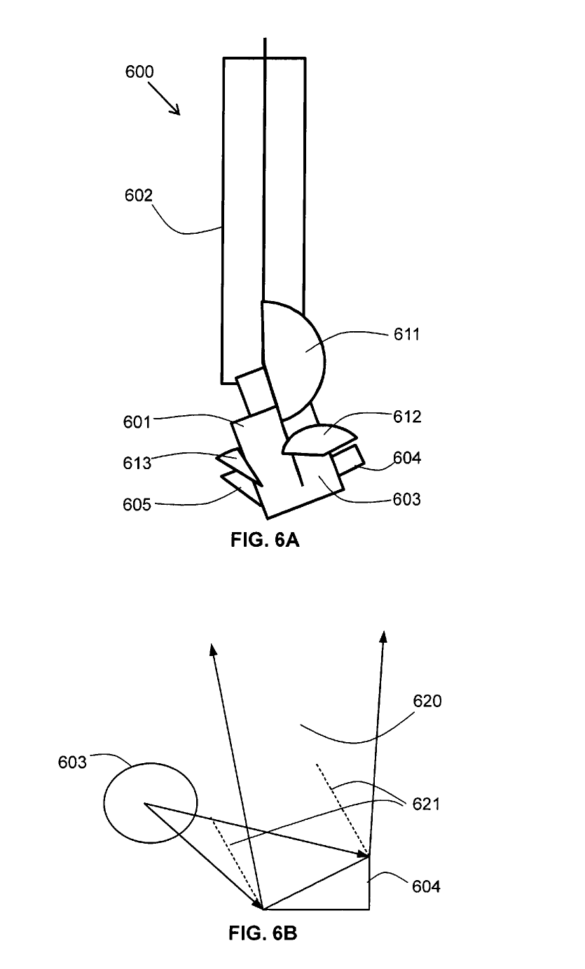

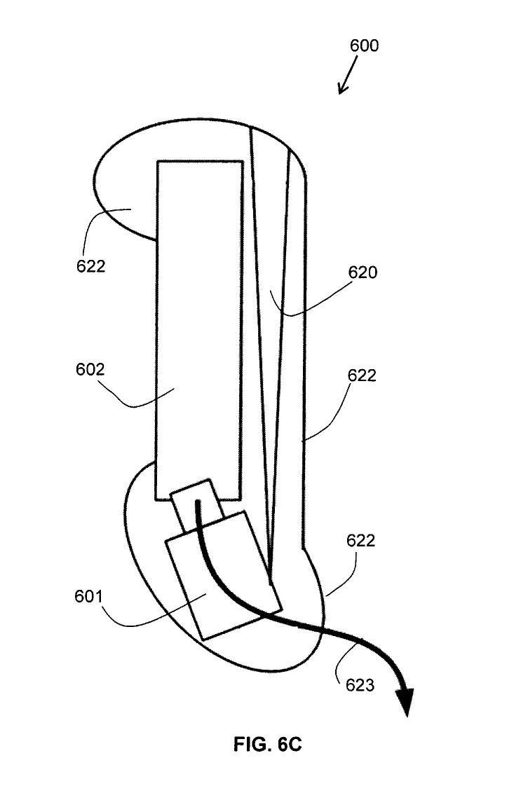

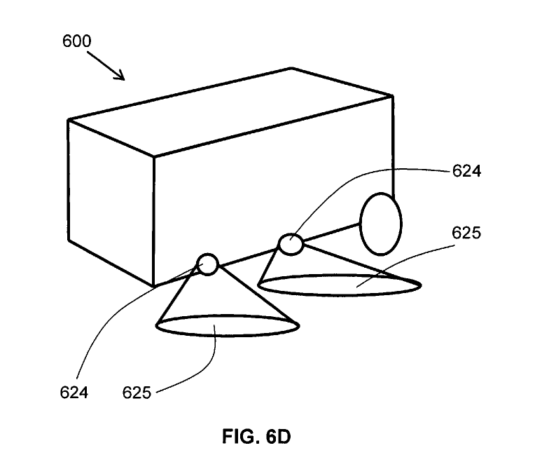

FIGS. 6A, 6B, 6C and 6D illustrate the described system as applied in the context of an articulated vehicle.

Monitoring the area surrounding a vehicle may include the following process. FIG. 6A is referred to which shows some angles when modeling an articulated vehicle 600. The vehicle may include a cab 601 and a trailer 602 with articulation between the two. In addition, the vehicle 600 includes a driver's position 603 and wing mirrors 604, 605 on each side of the vehicle 600.

Angles used in the process below are as follows:
Angle A1 611 which is the angle between the cab 601 and the trailer 602 when the vehicle is in a given position.
Angle A2 612 which is the angle between the position of the driver 603 and the driver's near wing mirror 604.
Angle A3 613 is the angle of the wheels to the cab 601.

FIG. 6B shows further details of angle A2 612. The driver's position 603 and the driver's near wing mirror 604 are shown. The angle A2 612 is a range of angles between the driver 603 and the mirror as shown. Construction lines 621 normal to the mirror 604 are shown and an angle of incidence Ai from the driver 603 is the same as an angle of reflection Ar resulting in a band of observable zone 620.

The following process is an example of the step of modeling the danger zones of a vehicle:
A vehicle has known dimensions;
A compound vehicle has known dimensions of each component part;
Given the geometric relation between component parts (an angle between the components, A1) the geometry of the compound vehicle is known;
This is enough to construct a basic outline, 3D model, or even physics engine model of the compound vehicle;
Knowing the angle of the wheels to the cab, angle A3, the model can be augmented. By adding knowledge of the wheel angle to the cab, the result of motion on the compound vehicle can be determined;
Motion of the vehicle and altering angle A3 may change:
   the volume occupied by the vehicle;
   the angle A1;
Assuming that the location of a driver inside the vehicle can be monitored and the geometry of the vehicle is known, the vector direction from the driver to the vehicle mirrors (essentially A2) may be determined, which in turn enables immediate determination of the region that is observable from the mirror;
All of the above is based upon basic geometric operations and optionally compound object formation which is the core of 3D physics engines;
Variation of angles A1, A2 and A3 all impact upon the observable zone for the driver, which may be determined based upon the above.

Referring to FIG. 6C, the same vehicle 600 as shown in FIG. 6A is considered a turning articulated vehicle, and further details of the described method and system are provided.

Stage 1: Based upon knowledge of the driver's position, the orientation of side mirrors and the vehicle dimensions, it is possible to create a simple model of the area surrounding the vehicle 600 that is observable by the driver—the observable area 620. Naturally, this also indicates the regions that are not observable by the driver. Based upon the orientation of the vehicle and knowledge of the zones that cannot be seen by the driver, it is possible to determine the danger zones 622. These zones are zones that may or may not be observable by the driver and areas of the road that the vehicle will pass over based upon the current vehicle configuration and direction of travel 623.

Note that while only one side of the vehicle is being considered, it would be both sides of the vehicle where this operation would be applied to; this is a prudent concern for articulated vehicles whereby the motion of the trailer during a sharp turn (such as those at junctions) will cause the trailer to move into both inside and outside lanes.

Stage 2: Using a lighting system 624 (FIG. 6D) that may be directed, light is shone onto the areas 625 that are defined as “danger zones” 622 (FIG. 6C) such the floor area is illuminated. In one embodiment, the location of these lights are low enough such that beam projection will not cause drivers, cyclists or pedestrians to become dazzled. For a large vehicle, this would consist of a series of lights placed on the underside of the vehicle and attached trailer, directed to the ground areas. This is illustrated in FIG. 6D which shows a plurality of lights 624 provided on the side of the vehicle 600. Illumination of the danger zones 622 (FIG. 6C) uses under slung lighting, which may direct the light to specific areas. While only one side of the vehicle is shown, this would be applied to both sides, and is not restricted to just the trailer.

Stage 3: The same areas that are determined and illuminated by stages 1 and 2 are monitored for zone violation, such as a cyclist entering the region. This is a clear safety concern. At this point directional sound is projected into the violated danger zone which would result in only persons within the projected zone are able to hear the audible warning.

An enhancement of this system would be incorporating a GPS aspect and local mapping system, which would enable the system to evolve the warning lighting in a pre-emptive manner. For instance, as a lorry approaches a junction this would be known. Additionally, if following a GPS route, then the direction in which the vehicle will turn will also be known; hence the areas around the vehicle that will be classified as danger zones may be illuminated in advance of reaching the junction. By doing this, it would give more forewarning to cyclists or even other vehicles that are in the vicinity of the lorry.

Consider a vehicle equipped with the system described. This vehicle is also equipped with a satellite navigation facility and the operator of the vehicle is following a route using the satellite navigation system. Based on this, warnings may be displayed using the described system. The current location of the vehicle and the future motion of the vehicle when approaching intersections or junctions is known. In combination, the above could be used to display warnings around the vehicle based upon proximity to known vehicle motions based upon the current route that is being followed.

### Example 1

Vehicle is following a route along a motorway. It is approaching a junction that it does not need to take. The warning system in operation is static upon approach and passage of junction.

### Example 2

Vehicle is following a route along a motorway. It is approaching a junction that it requires:
Severity of junction is assessed which will determine the perceived angles A1 and A3 that will enable navigation of the junction;
Upon approach of the junction, the warning system becomes active, illuminating the region that the vehicle intends to occupy in order to exit the motorway.

### Example 3

Vehicle is following a route through a city and is approaching a junction where the vehicle intends to turn left,
Severity of junction is assessed which will determine the perceived angles A1 and A3 that will enable navigation of the junction;
Upon approach of the junction, the warning system becomes active, indicating the regions that will become “danger zones” when navigating the junction.

As described herein, according to one aspect of the present invention, there is provided a method for providing a danger zone warning, comprising: identifying a volume and modeling the volume; determining one or more danger zones within the volume, wherein a danger zone is a sub-volume of the volume which is or will become hazardous for a person to be in; providing a visual indication on the ground of a danger zone; and providing a directed audio warning to a danger zone.

The method may also include monitoring a danger zone for entry of a person into the danger zone, and triggering providing one or both of the visual indication and directed audio warning when an entry is detected.

Providing a visual indication may provide a continuous visual indication. The method may include monitoring for entry of a person into the danger zone and triggering providing an additional visual indication warning when an entry is detected.

Modeling the volume may include: predicting a movement of a hazardous object within the volume; and providing the visual indication and directed audio warning prior to and/or during the predicted movement.

The volume may be a volume around a vehicle, and modeling the volume may include: modeling the vehicle's dimensions; and determining the driver's position and the orientation of side mirrors. Determining one or more danger zones within the volume may include: determining at least one danger zone as at least one sub-volume through which the vehicle is likely to travel; and determining observable zones of the at least one sub-volume. Providing a visual indication and/or providing a directed audio warning may be applied to the observable zone.

Monitoring a danger zone may include providing sensors to monitor movement in a danger zone.

Predicting a movement of a hazardous object within the volume may predict the movement of a vehicle by determining a vehicle's route and progress along the route.

In one embodiment, the vehicle is an articulated vehicle, and modeling the vehicle's dimensions includes modeling the angle of turn of a vehicle.

According to another aspect of the present invention, there is provided a danger zone warning system, comprising: a volume modeling component for identifying a volume and modeling the volume; a danger zone component for determining one or more danger zones within the volume, wherein a danger zone is a sub-volume of the volume which is or will become hazardous for a person to be in; a visual indication component for providing a visual indication on the ground of a danger zone; and an audio warning component for providing a directed audio warning to a danger zone.

The system may include a monitoring component for monitoring a danger zone for entry of a person into the danger zone and triggering the visual indication component and/or audio warning component when an entry is detected.

The visual indication component for providing a visual indication may provide a continuous visual indication. The system may include a monitoring component for monitoring for entry of a person into the danger zone and wherein the visual indication component may be for providing an additional visual indication warning when an entry is detected.

The modeling component for modeling the volume may include: a prediction component for predicting a movement of a hazardous object within the volume; and wherein the visual indication component and audio warning component are for providing the visual indication and directed audio warning prior to and/or during the predicted movement.

In one embodiment, the volume may a volume around a vehicle and the modeling component for modeling the volume includes: modeling the vehicle's dimensions; and determining the driver's position and the orientation of side mirrors. The danger zone component for determining one or more danger zones within the volume may include: determining at least one danger zone as at least one sub-volume through which the vehicle is likely to travel; and determining observable zones of the at least one sub-volume. Providing a visual indication and/or providing a directed audio warning may be applied to the observable zone.

The monitoring component for monitoring a danger zone may include a plurality of sensors to monitor movement in a danger zone.

The prediction component for predicting a movement of a hazardous object within the volume may predict the movement of a vehicle by determining a vehicle's route and progress along the route.

In one embodiment, the vehicle is an articulated vehicle, and modeling the vehicle's dimensions may include modeling the angle of turn of a vehicle.

According to yet another aspect of the present invention, there is provided a computer program stored on a computer readable medium and loadable into the internal memory of a digital computer, comprising software code portions, when said program is run on a computer, for performing the method steps of one aspect of the present invention.

According to yet a further aspect of the present invention, there is provided a method substantially as described with reference to the figures.

According to another aspect of the present invention, there is provided a system substantially as described with reference to the figures.

One or more aspects of the invention provide audible and visible warnings for danger zones in the vicinity of a vehicle. It would be an advance in safety if a cyclist/pedestrian could actually know if they are in a dangerous area, and not have to rely on the driver to predict their actions.

Aspects of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Improvements and modifications can be made to the foregoing without departing from the scope of aspects of the present invention.

What is claimed is:

1. A computer-implemented method of providing a danger zone warning, comprising:
identifying, by a processor, a volume, and modeling the volume;
determining one or more danger zones within the volume, wherein a danger zone is a sub-volume of the volume hazardous for a person to be in;
providing a visual indication on the ground of one danger zone; and
providing a directed audio warning to the one danger zone.

2. The computer-implemented method of claim 1, including:
monitoring the one danger zone for entry of a person into the one danger zone and triggering providing at least one of the visual indication and the directed audio warning when the entry is detected.

3. The computer-implemented method of claim 2, wherein the monitoring the one danger zone includes:
providing sensors to monitor movement in the one danger zone.

4. The computer-implemented method of claim 1, wherein the providing the visual indication comprises providing a continuous visual indication.

5. The computer-implemented method of claim 4, further comprising monitoring for entry of a person into the one danger zone and triggering providing an additional visual indication warning when the entry is detected.

6. The computer-implemented method of claim 1, wherein the modeling the volume includes:
predicting a movement of a hazardous object within the volume; and
providing the visual indication and the directed audio warning in at least one of prior to the predicted movement or during the predicted movement.

7. The computer-implemented method of claim 6, wherein the predicting the movement of the hazardous object within the volume comprises predicting the movement of a vehicle by determining a vehicle's route and progress along the route.

8. The computer-implemented method of claim 1, wherein the volume is the volume around a vehicle, and the modeling the volume includes:
modeling the vehicle's dimensions; and
determining a driver's position and an orientation of side mirrors.

9. The computer-implemented method of claim 8, wherein the vehicle is an articulated vehicle and the modeling the vehicle's dimensions includes modeling an angle of turn of the vehicle.

10. The computer-implemented method of claim 8, wherein the determining one or more danger zones within the volume includes:
determining at least one danger zone as at least one sub-volume through which the vehicle is likely to travel; and
determining observable zones of the at least one sub-volume.

11. The computer-implemented method of claim 10, wherein at least one of providing the visual indication or providing the directed audio warning is applied to an observable zone.

12. A computer system for providing a danger zone warning, comprising:
a memory; and
a processor in communication with the memory, wherein the computer system is configured to perform a method, said method comprising:
identifying a volume, and modeling the volume;
determining one or more danger zones within the volume, wherein a danger zone is a sub-volume of the volume hazardous for a person to be in;
providing a visual indication on the ground of one danger zone; and
providing a directed audio warning to the one danger zone.

13. The computer system of claim 12, wherein the method further comprises:
monitoring the one danger zone for entry of a person into the one danger zone and triggering providing at least one of the visual indication and the directed audio warning when the entry is detected.

14. The computer system of claim 12, wherein the modeling the volume includes:
predicting a movement of a hazardous object within the volume; and
providing the visual indication and the directed audio warning in at least one of prior to the predicted movement or during the predicted movement.

15. The computer system of claim 12, wherein the volume is the volume around a vehicle, and the modeling the volume includes:
modeling the vehicle's dimensions; and
determining a driver's position and an orientation of side mirrors.

16. A computer program product for providing a danger zone warning, comprising:
a computer readable storage medium readable by a processing circuit and storing instructions for execution by the processing circuit for performing a method comprising:
identifying, by a processor, a volume, and modeling the volume;
determining one or more danger zones within the volume, wherein a danger zone is a sub-volume of the volume hazardous for a person to be in;
providing a visual indication on the ground of one danger zone; and
providing a directed audio warning to the one danger zone.

17. The computer program product of claim 16, wherein the method further comprises:
monitoring the one danger zone for entry of a person into the one danger zone and triggering providing at least one of the visual indication and the directed audio warning when the entry is detected.

18. The computer program product of claim 16, wherein the modeling the volume includes:
predicting a movement of a hazardous object within the volume; and
providing the visual indication and the directed audio warning in at least one of prior to the predicted movement or during the predicted movement.

19. The computer program product of claim 18, wherein the predicting the movement of the hazardous object within the volume comprises predicting the movement of a vehicle by determining a vehicle's route and progress along the route.

20. The computer program product of claim 16, wherein the volume is the volume around a vehicle, and the modeling the volume includes:
modeling the vehicle's dimensions; and
determining a driver's position and an orientation of side mirrors.
